(19) United States
(12) Patent Application Publication
(10) Pub. No.: US 2017/0060339 A1
(43) Pub. Date: Mar. 2, 2017

(54) METHOD OF CONTROLLING TOUCH-SENSITIVITY OF TOUCH SCREEN AND ELECTORNIC DEVICE

(71) Applicant: Acer Incorporated, New Taipei City (TW)

(72) Inventor: Yu-Min CHANG, New Taipei City (TW)

(21) Appl. No.: 15/240,280

(22) Filed: Aug. 18, 2016

(30) Foreign Application Priority Data
Aug. 28, 2015 (TW) 104128307

(51) Int. Cl. G06F 3/041; G06F 3/044

(52) U.S. Cl. CPC G06F 3/0418; G06F 3/044

(57) ABSTRACT

A touch-sensitivity control method, which is applied to a touch screen, and an electronic device utilizing the same are provided. The method includes a memory circuit storing a predetermined value and a set of initial values; a detection circuit, coupled to the touch screen, driving the touch screen to execute a capacitor charging or discharging action and generate a capacitor charging or discharging result of the touch screen after the touch screen is turned on; an analyzing and sampling circuit, coupled to the detection circuit and the memory circuit, comparing the capacitor charging or discharging result with the predetermined value and outputting a comparison result; and a setting circuit, coupled to the analyzing and sampling circuit and the memory circuit, receiving the comparison result and setting multiple touch parameters applied to the touch screen according to the comparison result.

### CROSS REFERENCE TO RELATED APPLICATIONS

This Application claims priority of Taiwan Patent Application No. 104128307, filed on Aug. 28, 2015, the entirety of which is incorporated by reference herein.

### BACKGROUND OF THE INVENTION

Field of the Invention

The present invention relates to a touch screen, and in particular it relates to a touch screen using a touch-sensitivity control method.

Description of the Related Art

Nowadays, most electronic products have touch screens (tablets, smartphones, etc.), and users sometimes add some extra accessories on the touch screens of the electronic products (such as attaching protective films to the touch screens) according to personal demands.

However, the extra accessories may increase the touch distance between the user and the touch screen, leading to a change of the capacitors of the touch screen, which sometimes causes the operation to be less sensitive when the user operates the device. For example, the characters are disconnected when using hand writing; the line disconnects when drawing; and the user may even be unable to write characters, draw lines and pictures, etc.

In addition, different users may have different demands under different timing or operating conditions, which means that users may replace the extra accessories to satisfy the user's operational needs at the moment. The condition of replacing the extra accessories also can possibly cause the change of the capacitors of the touch screen. Different extra accessories can lead to different effects on the change of the capacitors of the touch screen, so if the touch screen is set by a fixed touch parameter, it will generate a situation in which the performance of the touch function is clearly inconsistent, or it may misread the touch operation due to the replacement of the extra accessories.

### BRIEF SUMMARY OF THE INVENTION

An embodiment of a touch-sensitivity control method applied to a touch screen comprises a process wherein, when the touch screen is turned on, a capacitor charging or discharging action of the touch screen is executed, and multiple touch parameters are set according to a capacitor charging or discharging result generated from the capacitor charging or discharging action.

An embodiment of an electronic device utilizing the touch-sensitivity control method is provided. The electronic device includes a touch screen, a memory circuit, a detection circuit, an analyzing and sampling circuit, and a setting circuit. The memory circuit stores a predetermined value and a set of initial values. The detection circuit is coupled to the touch screen. The detection circuit drives the touch screen to execute a capacitor charging or discharging action. The detection circuit generates a capacitor charging or discharging result of the touch screen after the touch screen is turned on. The analyzing and sampling circuit is coupled to the detection circuit and the memory circuit. The analyzing and sampling circuit compares the capacitor charging or discharging result with the predetermined value and outputs a comparison result. The setting circuit is coupled to the analyzing and sampling circuit and the memory circuit. The setting circuit receives the comparison result and sets multiple touch parameters applied to the touch screen according to the comparison result.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a block diagram of an electronic device according to an exemplary embodiment;

FIG. 1B is a block diagram of an electronic device according to an exemplary embodiment;

FIG. 2 is a schematic diagram of the touch screen with protective film according to an exemplary embodiment;

FIG. 3A is a flow chart of the touch-sensitivity control method according to an exemplary embodiment;

FIG. 3B is a flow chart of the touch-sensitivity control method according to another exemplary embodiment

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

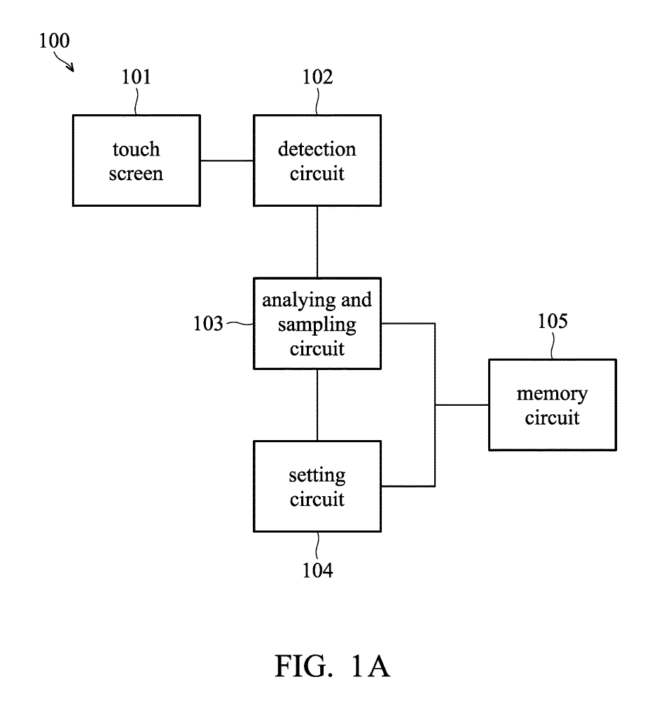

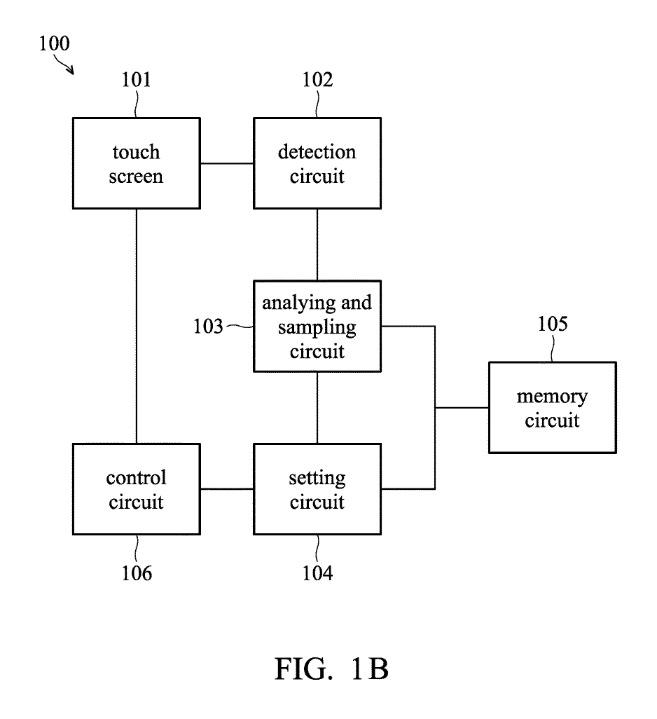

FIG. 1A is a block diagram showing an electronic device 100 according to an embodiment of present disclosure. The electronic device 100 may be, but is not limited to, a smartphone, a tablet, touch control TV, or digital photo frame. The electronic device 100 includes a touch screen 101, a detection circuit 102, an analyzing and sampling circuit 103, a setting circuit 104, and a memory circuit 105. The detection circuit 102 is coupled to the touch screen 101. The analyzing and sampling circuit 103 is coupled to the detection circuit 102. The setting circuit 104 is coupled to the analyzing and sampling circuit 103. The memory circuit 105 is coupled to the analyzing and sampling circuit 103 and the setting circuit 104.

The touch screen 101 is configured to receive a touch operation from the user. The memory circuit 105 is configured to store a predetermined value and a set of initial values. The detection circuit 102 executes a capacitor charging or discharging action to the touch screen 101 and then generates a capacitor charging or discharging result of the touch screen 101 after the touch screen 101 is turned on. In some embodiments, the detection circuit 102 charges or discharges the capacitors of multiple touch electrodes within the touch screen 101, and the capacitor charging or discharging result represents the amount of charge stored in the capacitors. The analyzing and sampling circuit 103 compares the capacitor charging or discharging result with the predetermined value. If the capacitor charging or discharging result matches the predetermined value, the analyzing and sampling circuit 103 exports a first outcome, or if the capacitor charging or discharging result does not match the predetermined value, when a protective film is placed on the touch screen 101 for example, the analyzing and sampling circuit 103 exports a second outcome. The setting circuit 104 is configured to receive the first or second outcome. If the setting circuit 104 receives the first outcome, the setting circuit 104 sets the multiple touch parameters of the touch screen 101 according to the set of initial values, or if the setting circuit 104 receives the second outcome, the setting circuit 104 sets the multiple touch parameters of the touch screen 101 according to the capacitor charging or discharging result. In some embodiments, the touch parameters includes, but are not limited to, a touch control sensitivity threshold value, a floating touch control sensitivity threshold value, a noise threshold value and a predetermined number of noise judging.

In some embodiments, when the setting circuit 104 receives the second outcome, the setting circuit 104 reduces the touch control sensitivity threshold value or the floating touch control sensitivity threshold value according to the capacitor charging or discharging result, which can prevent situations wherein the touch screen 101 is less responsive to the touch operation due to the extra accessory placed on the touch screen 101. In response to the action that reduces the threshold values set forth above, the noise threshold value is also reduced, and the predetermined number of noise judging is also changed and increased to prevent situations wherein the noise is misjudged to be a touch operation due to an action that reduces the threshold values set forth above. For example, within a period of time, only if the appearance times of a signal, which has the energy greater than the noise threshold value and lower than the touch control sensitivity threshold value, are greater than the predetermined number of noise judging, the electronic device 100 starts to determine, by a software program, the signal is a noise or a signal generated form touch operation.

In some embodiments, when the setting circuit 104 receives the second outcome, the setting circuit 104 matches the capacitor charging or discharging result with a lookup table to set the touch parameters of the touch screen 101. In some embodiments, when the setting circuit 104 receives the second outcome, the setting circuit 104 sets the touch parameters of the touch screen 101 by a control circuit 106 (as shown in FIG. 1B). The control circuit 106 sets the touch parameters of the touch screen 101 based on the capacitor charging or discharging result.

In some embodiments, the touch operation received by the touch screen 101 includes, but is not limited to, contacting the touch screen 101 with a finger or stylus, or through a floating (or hover) touch operation.

In some embodiments, the predetermined value stored in the memory circuit 105 is set at the time that the electronic device 100 is manufactured; that is, there are no extra accessories placed on the touch screen 101. In that case, the detection circuit 102 drives the touch screen 101 to execute a capacitor charging or discharging action on the capacitor of touch screen 101, and uses the capacitor charging or discharging result generated from the capacitor charging or discharging action as the predetermined value. The set of initial values stored in the memory circuit 105 are touch parameters corresponding to there being no extra accessories placed on the touch screen 101.

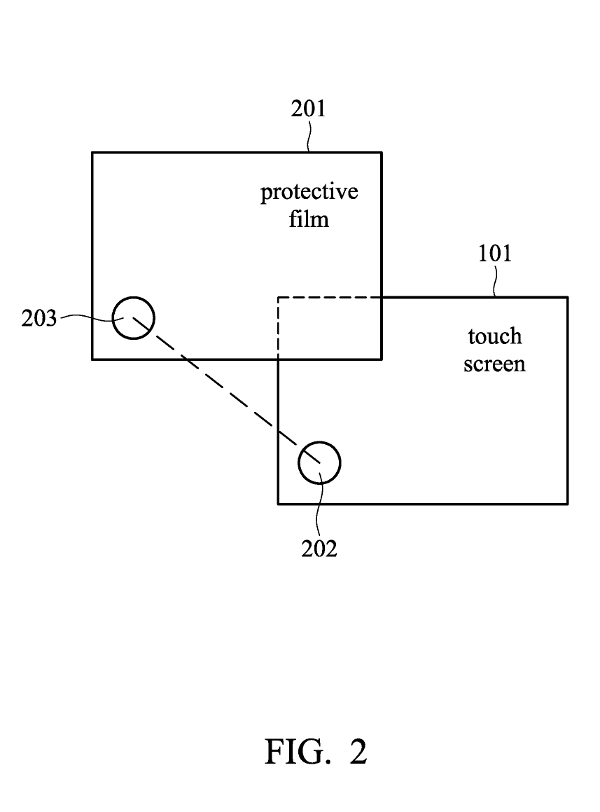

In some embodiments, the electronic device 100 can further comprise a protective film 201 placed on the touch screen 101, as shown in FIG. 2. The protective film 201 may be any type of protective film that is commonly applied to an electronic device. The protective film 201 includes a second region 203 made of a transparent conductive material, and the position of the second region 203 in the protective film 201 corresponds to the position of a first region 202 in the touch screen 101.

In some embodiments, the detection circuit 102 executes a capacitor charging or discharging action on the first region 202 of the touch screen 101 and generates a capacitor charging or discharging result of the touch screen 101 after the touch screen 101 is turned on. The analyzing and sampling circuit 103 compares the capacitor charging or discharging result with a predetermined value stored in the memory circuit 105. If the capacitor charging or discharging result matches the predetermined value, the analyzing and sampling circuit 103 exports a first outcome, or if the capacitor charging or discharging result does not match the predetermined value, the analyzing and sampling circuit 103 exports a second outcome. The setting circuit 104 is configured to receive the first or second outcome. If the setting circuit 104 receives the first outcome, the setting circuit 104 sets the multiple touch parameters of the touch screen 101 according to a set of initial values, or if the setting circuit 104 receives the second outcome, the setting circuit 104 sets the multiple touch parameters of the touch screen 101 according to the capacitor charging or discharging result.

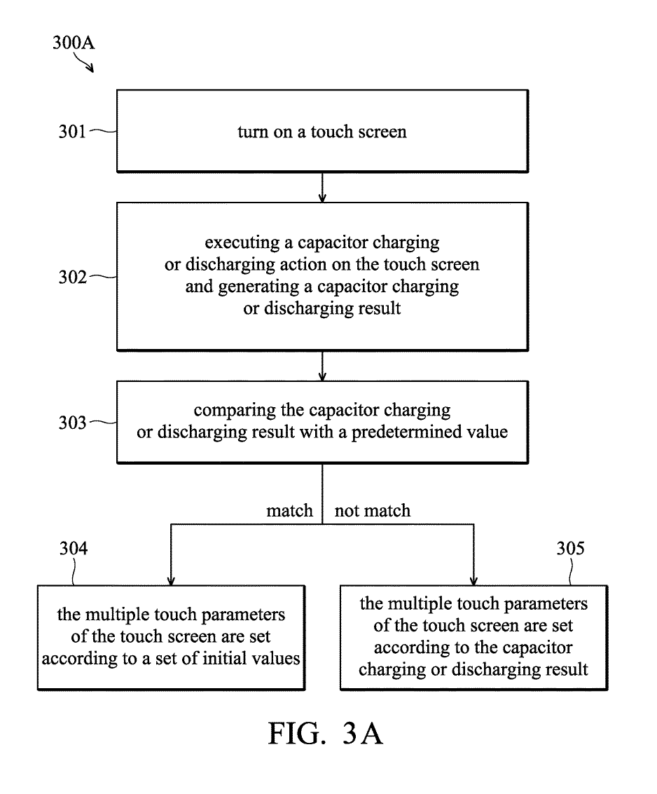

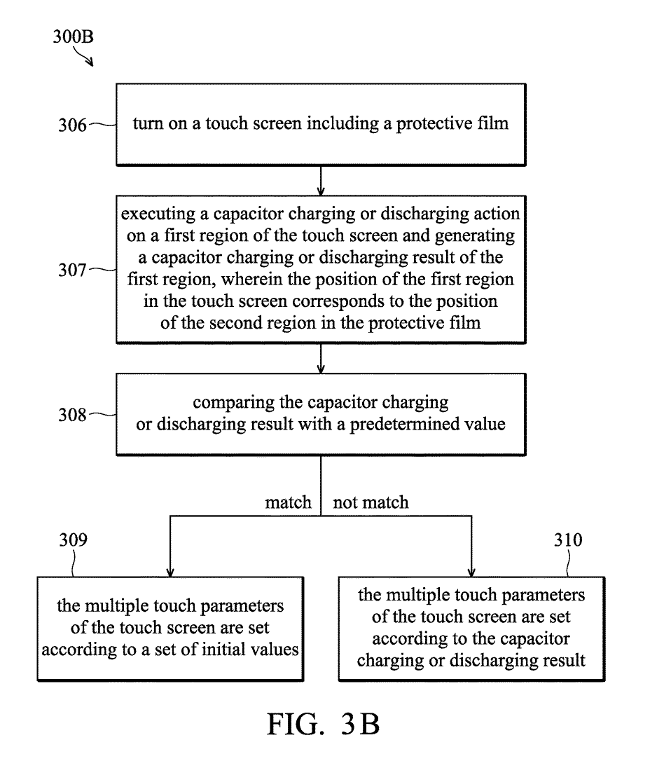

FIG. 3A is a flow chart 300A of the touch-sensitivity control method according to an exemplary embodiment. The flow starts at the turn on of a touch screen, which is shown in step 301. In step 302, the method includes executing a capacitor charging or discharging action on the touch screen and generating a capacitor charging or discharging result. In step 303, the method compares the capacitor charging or discharging result with a predetermined value. If the capacitor charging or discharging result matches the predetermined value, the flow goes to step 304. If the capacitor charging or discharging result does not match the predetermined value, the flow goes to step 305. In step 304, the multiple touch parameters of the touch screen are set according to a set of initial values. In step 305, the multiple touch parameters are set according to the capacitor charging or discharging result.

FIG. 3B is a flow chart 300B of the touch-sensitivity control method according to another exemplary embodiment. The flow starts at the turn on of a touch screen with a protective film, and a second region of the protective film is made of a transparent conductive material, which is shown in step 306. In step 307, the method includes executing a capacitor charging or discharging action on a first region of the touch screen and generating a capacitor charging or discharging result of the first region, wherein the position of the first region in the touch screen corresponds to the position of the second region in the protective film. In step 308, the method compares the capacitor charging or discharging result with a predetermined value. If the capacitor charging or discharging result matches the predetermined value, the flow goes to step 309. If the capacitor charging or discharging result does not match the predetermined value, the flow goes to step 310. In step 309, the multiple touch parameters of the touch screen are set according to a set of initial values. In step 310, the multiple touch parameters are set according to the capacitor charging or discharging result.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch-sensitivity control method applied to a touch screen comprising:
executing a capacitor charging or discharging action of the touch screen when the touch screen is turned on; and
setting multiple touch parameters according to a capacitor charging or discharging result generated from the capacitor charging or discharging action.

2. The control method as claimed in claim 1 further comprises:
providing a protective film that includes a second region;
placing the protective film on the touch screen, and making the position of the second region in the protective film correspond to the position of a first region in the touch screen;
wherein the capacitor charging or discharging action is to charge or discharge the capacitor in the first region of the touch screen.

3. The control method as claimed in claim 1 further comprises:
setting the touch parameters according to a set of initial values when the capacitor charging or discharging result matches a predetermined value; and
setting the touch parameters by executing a first action when the capacitor charging or discharging result does not match the predetermined value.

4. The control method as claimed in claim 3, wherein the first action is to match the capacitor charging or discharging result with a lookup table to set the touch parameters.

5. The control method as claimed in claim 3, wherein the first action is to input the capacitor charging or discharging result to a control circuit, and set the touch parameters through the control circuit.

6. The control method as claimed in claim 1, wherein the touch parameters are a threshold value, a noise threshold value and a predetermined number of noise judging.

7. An electronic device comprises:
a touch screen;
a memory circuit, storing a predetermined value and a set of initial values;
a detection circuit, coupled to the touch screen, driving the touch screen to execute a capacitor charging or discharging action and generating a capacitor charging or discharging result of the touch screen after the touch screen is turned on;
an analyzing and sampling circuit, coupled to the detection circuit and the memory circuit, comparing the capacitor charging or discharging result with the predetermined value and outputting a comparison result; and
a setting circuit, coupled to the analyzing and sampling circuit and the memory circuit, receiving the comparison result and setting multiple touch parameters applied to the touch screen according to the comparison result.

8. The electronic device as claimed in claim 7, further comprises a protective film placed on the touch screen, and the protective film includes a second region whose position in the protective film corresponds to the position of a first region in the touch screen;
wherein the second region is made of a transparent conductive material;
wherein the capacitor charging or discharging action is to charge or discharge the capacitor in the first region of the touch screen.

9. The electronic device as claimed in claim 7, wherein when the comparison result shows the capacitor charging or discharging result matches the predetermined value, the setting circuit sets the touch parameters according to the set of initial values; and
when the comparison result shows the capacitor charging or discharging result does not match the predetermined value, the setting circuit sets the touch parameters by executing a first action.

10. The electronic device as claimed in claim 9, wherein the first action is to match the capacitor charging or discharging result with a lookup table to set the touch parameters.

11. The electronic device as claimed in claim 9, wherein the first action is to input the capacitor charging or discharging result to a control circuit, and set the touch parameters through the control circuit.

12. The electronic device as claimed in claim 7, wherein the touch parameters are a touch control sensitivity threshold value, a floating touch control sensitivity threshold value, a noise threshold value and a predetermined number of noise judging.
